(19) United States
(12) Patent Application Publication
(10) Pub. No.: US 2020/0027141 A1
(43) Pub. Date: Jan. 23, 2020

(54) SYSTEM AND METHOD FOR ANALYSIS AND PRESENTATION OF USED VEHICLE PRICING DATA

(71) Applicant: TrueCar, Inc., Santa Monica, CA (US)

(72) Inventors: David E. Tompkins, Pacific Palisades, CA (US); Jichuan J. Feng, South El Monte, CA (US)

(21) Appl. No.: 16/433,521

(22) Filed: Jun. 6, 2019

Related U.S. Application Data
(60) Provisional application No. 62/699,503, filed on Jul. 17, 2018.

(51) Int. Cl. G06Q 30/02; G06Q 30/06

(52) U.S. Cl. CPC G06Q 30/0283; G06Q 30/0206; G06Q 30/0641; G06Q 30/0627; G06Q 30/0205

(57) ABSTRACT

Embodiments of a vehicle data system are disclosed. A user can be presented with an interface where the user can make a variety of determinations. After the user requests data on a specific vehicle configuration, a frontend process handles user-provided data in conjunction with the data calculated in the backend process to ensure that the results are better tailored to the user's specific vehicle attributes. The results can be presented in an interface that includes useful pricing data presented in a useful manner.

### RELATED APPLICATIONS

This application claims a benefit of priority under 35 U.S.C. § 119(e) from U.S. Provisional Application No. 62/699,503, filed Jul. 17, 2018, entitled “SYSTEM AND METHOD FOR ANALYSIS AND PRESENTATION OF USED VEHICLE PRICING DATA.” All applications referenced in this paragraph are fully incorporated by reference herein for all purposes.

### COPYRIGHT NOTICE

A portion of the disclosure of this patent document contains material which is subject to copyright protection. The copyright owner has no objection to the facsimile reproduction by any one of the patent document or the patent disclosure as it appears in the Patent and Trademark Office patent file or records, but otherwise reserves all copyright rights whatsoever.

### TECHNICAL FIELD

The present disclosure relates to the aggregation, analysis, and presentation of transaction and pricing data related to vehicles, including used vehicles.

### BACKGROUND

Buyers and Sellers have a difficult time determining what the right price is for a used vehicle. Buyers also face confusion over the trade-offs they face between price and other factors. This difficulty is exacerbated by the vagaries of used car transactions, especially in comparison with the sale or purchase of new cars.

For example, (a) Condition is a critical factor to the value of a used car but it doesn't apply to new cars and it is not revealed within used listings or transaction data; (b) Mileage on a used car affects the value whereas it can be ignored on new cars; (c) In general, the older the vehicle, the less the price; age is not an issue with new cars; (d) Used car pricing has a much wider range of model years and many more vehicle models to work with including groups of model years with minimal changes (referred to as “generations”); new cars only include at most vehicles in the most recent 2 or 3 model years; (e) the volume of listings and transactions drops dramatically for older vehicles, especially for those 10+ years old cars; thus, far fewer data points are available for analysis (while, in most cases, an adequate number of comparable new car transactions are available); (f) Option availability varies between specific used cars, with some of them adding considerable value; (g) Geographies currently used to provide market guidance tend to be defined be leveraging market definitions created for other purposes (e.g., DMA for TV markets, State for government purposes). In summary, each used car is unique, unlike new cars where there is generally a plentiful selection for each model and cars can even be custom configured. To further complicate pricing calculations, many used cars are close substitutes for each other while some configurations are sought out specifically.

It is thus desirable to account for these various challenges and factors when providing a buyer or seller with pricing data associated with a specified used vehicle, including for example, a transaction sales price, a trade-in price, a list price, an expected sale price or range of sale prices or how long the vehicle has been for sale. It is also desired that certain of the pricing data be presented in conjunction with the data associated with the specified used vehicle. It is further desired that this list price and transaction price data may be presented as a statistical distribution of the data along with certain pricing data including such price points as market low sale price, market average sale price or market high sale price presented relative to the data distribution.

### SUMMARY

To those ends, among others, embodiments of systems and methods for the aggregation, analysis, and display of data for used vehicles are thus disclosed. In particular, in certain embodiments, historical transaction data for used vehicles may be obtained and processed to determine pricing data, where this determined pricing data may be associated with a particular configuration of a vehicle. The user can then be presented with an interface pertinent to the vehicle configuration utilizing the aggregated data set or the associated determined data where the user can make a variety of determinations. This interface may, for example, be configured to present the historical transaction data visually, with the pricing data such as a trade-in price, a list price, an expected sale price or range of sale prices, market low sale price, market average sale price, market high sale price, etc. presented relative to the historical transaction data.

In certain embodiments, advanced algorithms may be applied to approximate the condition of each vehicle and to determine its option content value. Clustering of automotive data will be used to define relevant markets separately for commodity and specialty vehicles. Clustering and linking of data may also be used to combine years, makes, models, and trims in an intelligent way in order to maximize the sample used to generate market price information for each vehicle.

In one embodiment, modeling that accounts for various factors may be utilized to accurately estimate sale and listing prices for a given used car. Embodiments of such a modeling approach may include the development of a set of interrelated models associated with vehicle trims to facilitate estimation of the base trade-in, sale, and listing value of a used car in a logical sequence. Key factors may be incorporated into regression models to estimate their individual impact or interactions. These factors may include, for example: mileage; condition; geographic information (customized region based on clustering characteristics such as built from groups of zip codes); seasonality by region; demographic information (household income, house value, etc.); vehicle attributes (transmission, engine, drive train, hybrid, electric, etc.); vehicle options that have estimated positive or negative impacts on price; days in inventory; modeled proxies for vehicle condition; etc. The days-in-inventory factor may be utilized to capture the desirability and condition for that specific used car, with the expected price varying depending on how long the vehicle has been for sale.

In certain embodiments, in addition to the above factors that are considered in regression models, clustering of model years, trims, or models may also be applied to overcome sparse data. The purpose of this clustering may be to identify vehicles that behave similarly so that data points can be pooled together for regression analysis. Thus, using embodiments of this modeling or regression, pricing data, including estimated sales prices or listing prices may be determined.

Using such estimated sales prices or listing prices (e.g., a price at which the car may be offered for sale) for a used vehicle, a buyer or seller can better make decisions regarding the purchase or sale of a used vehicle, as the market factors corresponding to the vehicle may be better understood. In fact, embodiments of such vehicle data systems can help everyone involved in the used car sales process including sellers (e.g. private sellers, wholesalers, dealers, etc.), consumers, and even intermediaries by presenting both simplified and complex views of data. By utilizing visual interfaces in certain embodiments pricing data may be presented as a price curve, bar chart, histogram, etc., which reflects quantifiable prices or price ranges relative to reference pricing data points. Using these types of visual presentations may enable a user to better understand the pricing data related to a specific vehicle configuration. Such interfaces may be, for example, a website such that the user can go to the website to receive relevant information concerning a specific vehicle configuration, including market context around specific vehicle configurations offered for sale. This information may also be used to help consumers understand the trade-offs between price and other factors such as mileage, model year, condition, and option content.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts one embodiment of a topology including a vehicle data system.

FIG. 2 depicts one embodiment of a method for determining pricing data.

FIG. 3 depicts an exemplary bin for use in presenting pricing data.

FIG. 4 depicts an embodiment of a method for building a modeling system to determine pricing data.

FIG. 5 depicts an embodiment for applying the modeling system to determine pricing information for a specific vehicle.

FIG. 6 depicts exemplary pricing data produced for display.

FIG. 7 depicts one embodiment of an interface.

FIG. 8 depicts one embodiment of an interface.

FIG. 9 depicts one embodiment of an interface.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions or rearrangements within the spirit or scope of the underlying inventive concept will become apparent to those skilled in the art from this disclosure.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices.

Attention is now directed to the aggregation, analysis, display and of pricing data for vehicles, including used vehicles. In particular, actual sales transaction and listing price data may be obtained from a variety of sources. This historical data may be aggregated into data sets and the data sets processed to determine desired pricing data, where this determined pricing data may be associated with a particular configuration (e.g. make, model, power train, options, mileage, etc.) of a vehicle. An interface may be presented to a user where a user may provide relevant information such as desired attributes of a vehicle configuration, a geographic area, etc. The user can then be presented with individual pieces of inventory matching those criteria along with a display pertinent to the provided information utilizing the aggregated data set or associated determined pricing data where the user can view the average list price, along with additional pricing information to provide a market perspective to evaluate the offering price for that specific vehicle.

In one embodiment, the average listing price or range of expected prices may have additional information associated with them which reflect the expected selling price. The list price and the expected sale price may be linked to a number of average days to sale such that the list price, expected sale price and average days to sale may be interdependent. The interface may offer a user the ability to adjust one or more pieces of this pricing data (e.g. the average number of days to sale) and thereby adjust the interface to present the market pricing data calculated in response to this adjustment. Furthermore, such pricing data may be presented in conjunction with transaction data associated with the specified used vehicle. This transaction data may be presented as a distribution of the transaction data and include pricing data including such price points such as market low, market average or market high sale, listing, or trade-in price.

In certain embodiments, then, using data feeds from multiple sources, model variables may be constructed and multivariate regressions for generating pricing data for used car valuations may be built. In the used car space, there are multiple price points that are of interest, including specifically list prices, sale prices, and trade-in prices.

Thus, embodiments of the systems and methods disclosed herein can provide accurate pricing guidance with respect to at least each of these price points, along with a range of sale prices that may be useful for both a buyer or a seller.

To provide such information, embodiments may utilize the following approach: when vehicle information is received (e.g., from a seller or other source), variables about the specifics of that vehicle are obtained. For example, data on year, make, model, options, transmission, engine cylinders, color, condition, mileage, original MSRP and invoice price may be obtained. In addition, an algorithm may be applied to estimate condition based on available information and to extract options information from seller's free-form text comments. From this data, a baseline valuation can be obtained. This valuation can be calculated in multiple ways depending on the embodiment, but, in one embodiment may effectively be a depreciation value for the class of vehicle associated with the vehicle selected by the user. Also, at this time, the vehicle's “bin” may be specified: the bin is defined as the group of vehicles in the historical listings and transactions that are of the same make, model, body type, same year (or generation), similar time frame, or similar geography. Recent transactions (e.g. within a certain time window) within the same bin may be evaluated based on a model (which will be described in more detail later herein) to make further refinements to the price being anticipated for the vehicle. This process may be done by linked models for listing, sale, and trade-in prices.

In some embodiments, to increase the efficiency of the process while still tailoring the results to the individual user's unique specifications, at least some pre-calculation (e.g. calculation done before a specific request from a user for data for a specified vehicle) may be done. This pre-calculation may be done in what will herein be referred to as the “backend.” The backend as used herein means that it may not be done in response to a user request, or may be done at any point before a particular user requests data on a specified vehicle. Thus, for example, if certain calculations are on certain time frame (e.g. every day, every week, every hour, etc.), these may be considered to be done on the backend. Additionally, for example, if calculations are done before a first user specifies a vehicle and requests pricing data on that vehicle, pre-calculation may have been done on the backend with respect to that first user and his request. If certain calculations are done after the first user has received his information but before a second user requests data on a specified vehicle, those calculations may be understood to have been done on the backend. When such pre-calculation occurs, after the user requests data on a specified vehicle configuration, there may be a process flow for handling this user provided incremental data (for example, in conjunction with the data calculated in the backend) to ensure the results are better tailored to the user's specific vehicle attributes.

Embodiments of the above systems and methods will now be described herein in more detail. Embodiments as depicted may be understood also with reference to U.S. Pat. No. 9,754,304, entitled “System and Method for Aggregation, Analysis, Presentation and Monetization of Pricing Data for Vehicles and Other Commodities”, issued to Taira et al on Sep. 5, 2017 and U.S. Pat. No. 10,108,989, entitled System and Method for Analysis and Presentation of Used Vehicle Pricing Data”, issued to Swinson et al on Oct. 23, 2018, both of which are incorporated fully herein in their entirety for all purposes.

As an overview, initially a general description on data and data sources utilized will be described. Then, the method utilized to construct a model based on a research data set is described. In certain embodiments, models may be constructed on one or more different levels, for example, a model may be built on a national level, a make level, a model level, a bin level, etc. Furthermore, there may be a set of models for each price which it is desired to determine. For example, there may be a set of models for list price, a set of models for sale price and a set of models for trade in price. Thus, for example, there may be a set of linked models: a set of models for list price, each model corresponding to a bin; a set of models for sale price, each model corresponding to a bin; and a set of models for trade-in price, each model corresponding to a bin. Finally, the implementation and use of a model is described, including the use of such a model in the frontend (calculations done in response to a user's request for data for a specific vehicle configuration) phases of that implementation.

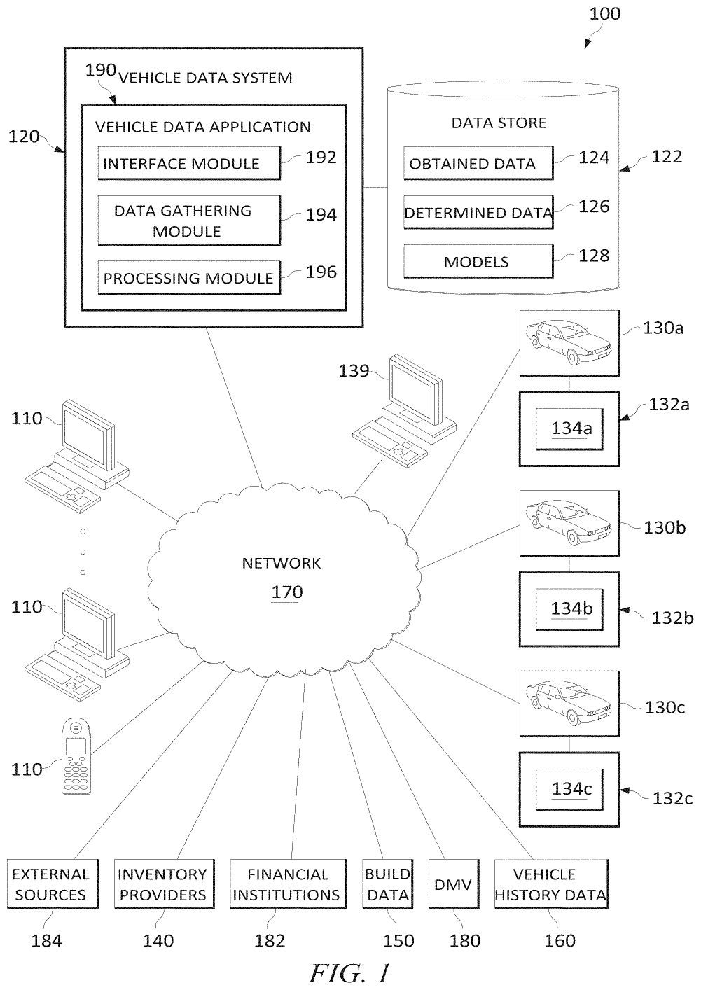

Embodiments of the systems and methods of the present invention may be better explained with reference to FIG. 1 which depicts one example of a topology which may be used with certain embodiments. Topology 100 comprises a set of entities including vehicle data system 120 (also referred to herein as the TrueCar system) which is coupled through network 170 to computing devices 110 (e.g. computer systems, personal data assistants, kiosks, dedicated terminals, mobile telephones, smart phones, etc.), and one or more computing devices at inventory providers 140, build data providers supplying vehicle configuration data (OEMs and third parties) 150, providers of individual vehicle history information 160, financial institutions 182, external information sources 184, departments of motor vehicles (DMV) 180, and one or more associated point of sale locations, in this embodiment, car dealers 130. Network 170 may be for example, a wireless or wireline communication network such as the Internet or wide area network (WAN), publicly switched telephone network (PSTN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments of the present invention. These applications may include a vehicle data application 190 comprising one or more applications (instructions embodied on a computer readable media) configured to implement an interface module 192, data gathering module 194, and processing module 196 utilized by the vehicle data system 120. Furthermore, vehicle data system 120 may include data store 122 operable to store obtained data 124, data 126 determined during operation, models 128 which may comprise a set of dealer cost model or price ratio models, or any other type of data associated with embodiments of the present invention or determined during the implementation of those embodiments.

Vehicle data system 120 may provide a wide degree of functionality including utilizing one or more interfaces 192 configured to for example, receive and respond to queries from users at computing devices 110; interface with inventory providers 140, build data providers 150, vehicle history providers 160, financial institutions 182, DMVs 180, external sources 184 or dealers 130 to obtain data; or provide data obtained, or determined, by vehicle data system 120 to any of inventory companies 140, manufacturers 150, sales data companies 160, financial institutions 182, DMVs 180, external data sources 184, or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, or almost any other type of interface which it is desired to utilize in a particular context.

In general, then, using these interfaces 192, vehicle data system 120 may obtain data from a variety of sources, including one or more of inventory providers 140, build data providers 150, vehicle history providers 160, financial institutions 182, DMVs 180, external data sources 184, or dealers 130 and store such data in data store 122. This data may be then grouped, analyzed or otherwise processed by vehicle data system 120 to determine desired data 126 or models 128 which are also stored in data store 122. A user at computing device 110 may access the vehicle data system 120 through the provided interfaces 192 and specify certain parameters, such as a desired vehicle configuration. The vehicle data system 120 can select a particular set of data in the data store 122 based on the user specified parameters, process the set of data using processing module 196 and models 128, generate interfaces using interface module 192 using the selected data set and data determined from the processing, and present these interfaces to the user at the user's computing device 110. More specifically, in one embodiment, interfaces 192 may visually present the selected data set to the user in a highly intuitive and useful manner.

In particular, in one embodiment, a visual interface may present at least a portion of the selected data set as a price curve, bar chart, histogram, etc. that reflects quantifiable prices or price ranges (e.g. “lower prices,” “sale price,” “market average price,” “higher prices” etc.) relative to reference pricing data points or ranges (e.g., trade in price, list price, market low sale price, market average sale price, market high sale price, etc.). Using these types of visual presentations may enable a user to better understand the pricing data related to a specific vehicle configuration.

Turning to the various other entities in topology 100, dealer 130a may represent a retail outlet for vehicles supplied by one or more OEMs, 130b may represent a used vehicle dealer, and 130c may be a dealer for both. To track or otherwise manage sales, finance, parts, service, inventory and back office administration needs dealers 130 may employ a dealer management system (DMS) 132. Since many DMS 132 are Active Server Pages (ASP) based, transaction data 134 may be obtained directly from the DMS 132 with a “key” (for example, an ID and Password with set permissions within the DMS system 132) that enables data to be retrieved from the DMS system 132, supplying the vehicle data system 120 with transaction and list pricing data as input to the data store 122. Many dealers 130 may also have one or more web sites which may be accessed over network 170, where pricing data pertinent to the dealer 130 may be presented on those web sites, including any pre-determined, or upfront, pricing from the DMS 132. This price is typically the “no haggle” (price with no negotiation) price and may be used as the dealer's offer price within the vehicle data system 120. The dealer may also provide offer pricing directly through the TrueCar Dealer Portal 139, supplying the vehicle data system 120.

Inventory companies 140 may be one or more inventory polling companies, inventory management companies or listing aggregators which may obtain and store inventory data from one or more of dealers 130 (for example, obtaining such data from DMS 132). Inventory polling companies are typically commissioned by the dealer to pull data from a DMS 132 and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, Autotrader, FordVehicles.com).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.), type of registrant (e.g., rental car providers), and sales transaction prices for tax purposes. Additionally, DMVs may maintain tax records of used vehicle transactions, inspection, mileages, etc.).

Financial institution 182 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Vehicle history data providers 160 may include any entities that collect any type of activity data around individual vehicles (VINs). They may collect and compile data from DMVs, automobile dealers, repair shops, insurance companies, and other companies that come into contact with vehicles in service. These companies may have formal agreements that enable them to syndicate the compiled data for the purposes of external purchase of the data by other data companies, dealers, and OEMs. The data they supply may include the number of owners plus the number and dates of accidents, repairs, and the performance of routine maintenance.

Build data providers 150 are either manufacturers of vehicles or those entities which collect information from manufacturers that describes the exact content of individual vehicles (VINs). They may also provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various sources, online or otherwise, which may provide other types of desired data, for example data regarding vehicles, pricing, demographics, economic conditions, markets, locale(s), consumers, proxies for condition, etc.

Thus, as can be seen, from the above data sources, vehicle data system 120 can obtain and store at least the following data sets (which may be stored, for example, as obtained data 124): (a) Used vehicle sale transactions: this dataset comprises the individual historical sales transactions, which includes the core information about the sale including the vehicle year, make, model, trim, identification, region, sale price, mileage, condition, options, etc.; (b) Used vehicle listing data: this dataset captures the historical as well as current listings available in the market, which includes vehicle year, make, model, trim, identification, region, listing price, mileage, condition, etc.; (c) Geography data: this dataset comprises mappings across zip code, city, state, region, DMA, etc.; (d) Demographic data: this dataset has demography information such as median household income, median house value at a geographic (e.g. zip code, city, state, region, DMA, etc.) level; (e) Vehicle data: this dataset comprises the vehicle information, such as vehicle year, make, model, trim, engine, transmission, drivetrain, body type, option, MSRP, invoice, etc.; (f) Vehicle residual value data: this data is published by an external data source (e.g. vehicle leasing or finance companies) and comprise estimates of the residual value of used vehicles; and (g) Title history data: this data is specific to individual vehicles such as number of owners, clean title or not, etc.

It should be noted here that not all of the various entities depicted in topology 100 are necessary, or even desired, in embodiments of the present invention, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments of the present invention.

Using the available data sets then, embodiments may accurately estimate sale price and listing price for a given used vehicle. Sale price is the amount the user paid to purchase the car or it is anticipated a user will pay to purchase a car; listing price refers to the price that the car was/is listed/advertised for on the market. Given both estimations, any owner who wants to buy or sell a vehicle can do so with an accurate understanding of the market value of the car.

As discussed above, used car pricing is a more challenging problem compared to new car pricing for a variety of reasons, including considerations of condition, mileage, age, variety, sales velocity, configuration, etc. Embodiments as disclosed herein may account for substantially all these factors and allows us an accurate estimation of sale and listing prices for a given used car.

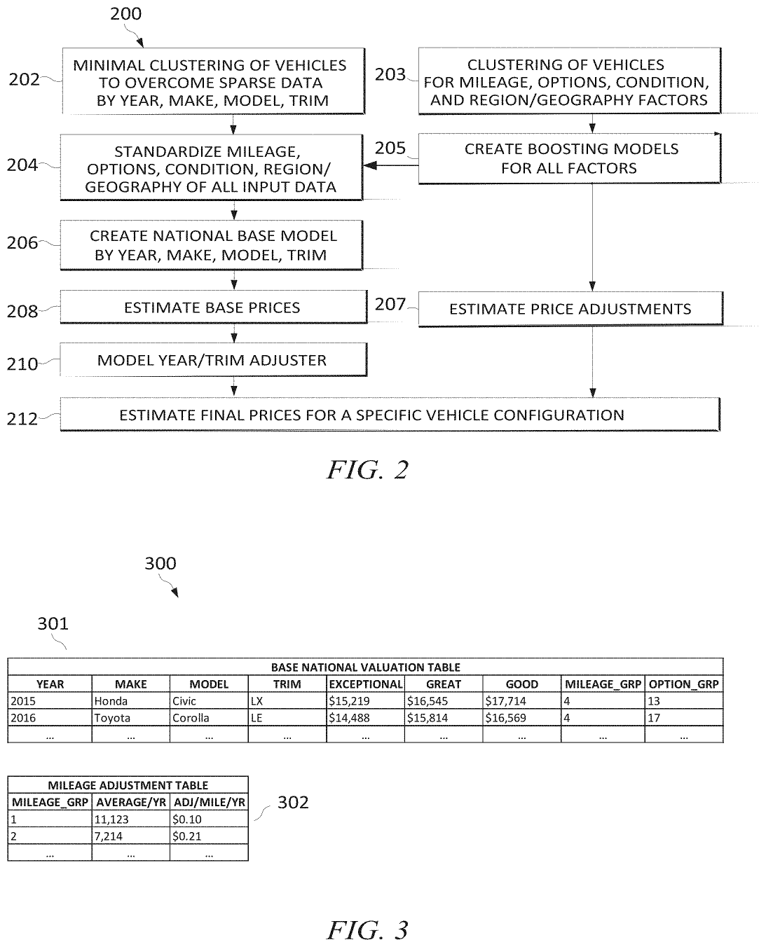

In particular, turning now to FIG. 2, a high-level flow diagram 200 illustrating one embodiment of a method for modeling and determining used vehicle pricing data is shown. Initially, clustering approaches (step 202) may also applied to overcome sparse data caused, for example, by the drop in sales velocity or the static configuration of a used vehicle. The purpose of clustering is to identify similar vehicles so that data points can be pooled together for regression analysis only when necessary for sample-size reasons.

In a separate process, a longer timeframe of data is clustered in multiple ways to support the price-adjustment models (step 203). For example, all sports cars may form one cluster and all pickup trucks another one for the purpose of determining average mileage per year and appropriate adjustments for mileage above or below the average. A separate model is built for each type of adjustment, with the exception of region and seasonality which are in a combined model (step 205).

The boosting models are used to adjust all input data to turn each data point into an “average” vehicle-one with average mileage, average condition, average option content, etc. (step 204). Using the adjusted raw data, regression models are built for each year/make/model/trim (step 206). The output of these models is the base national price average and distribution for vehicles with average mileage, option content, etc. (step 208).

For each make/model/generation, average prices and the price distribution are compared by model year and trim to ensure a logical progression. For example, newer model year prices are higher than older model year prices and trims with more expensive features have higher or the same price as other trims (step 210). Any necessary adjustments are made to the model years/trims with the smallest sample size, continuing with the next smallest until a logical progression is achieved.

The base prices (step 208), adjusted for model year and trim logic (step 210), can be combined with the pricing adjustments output by all of the boosting models (step 207) to produce the market pricing information for any specific configuration (step 212). A specific unit of inventory is matched to the model output to create a custom market-level price which can then be used to provide buyers and sellers more insights into pricing. In one embodiment, the estimation can provide market low, average, and high prices. These prices are estimated based upon the relevant historical sales, a sale price regression analysis, and further adjustments to align with the specific configuration of a vehicle (selected from inventory by a user).

FIG. 3 shows examples of potential embodiments of the lookup tables generated by embodiments of the method described with respect to FIG. 2. The first table 301 provides one example of a layout for pricing distribution information for a base vehicle (e.g., as described with respect to step 210 of FIG. 2); the second table 302 shows an example of a price adjustment table (e.g., as described with respect to step 207 of FIG. 2). When matched with a vehicle description, these tables plus the others generated (e.g., as described with respect to step 207 of FIG. 2) will produce price estimates for that specific vehicle (e.g., as described with respect to step 212 of FIG. 2).

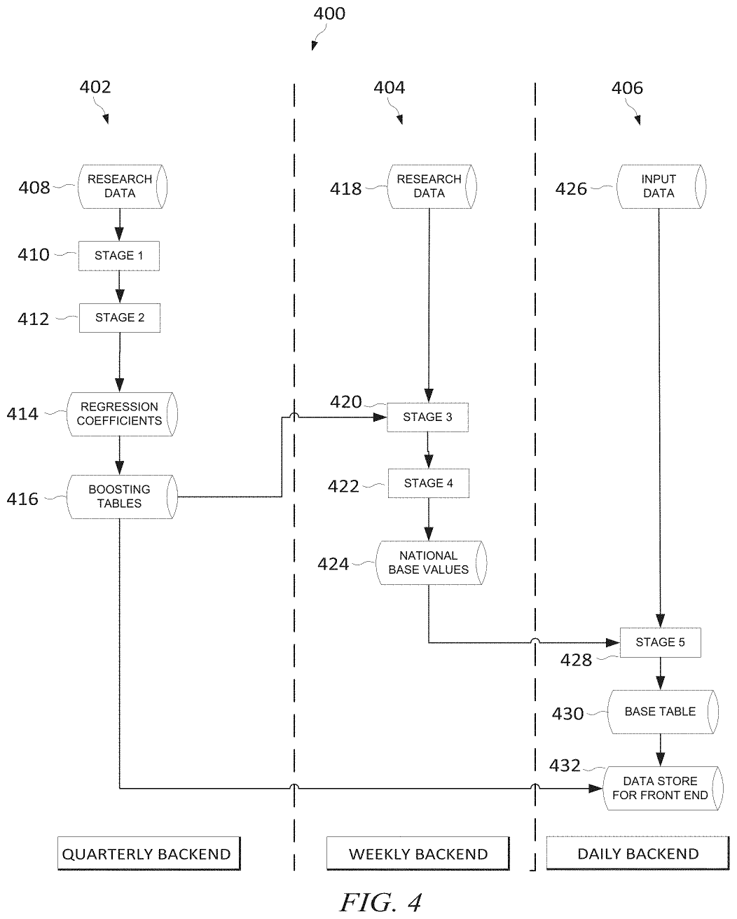

Turning now, to FIG. 4, one embodiment of a method for the aggregation, analysis, modeling, and presentation of transaction and pricing data related to vehicles, including used vehicles, is presented in greater detail. The method 400 may be divided into three types of backend processing 402, 404, and 406 which provide information to support frontend processing. These three types of backend processing may be done, for example, at different time periods. For example, one of the backend process (e.g., 402) may be done quarterly, another one of the backend processes (e.g., 404) may be done weekly while yet another one of the backend processes (e.g., 406) may be done daily. The backend processing 402 may entail the development of one or more models based upon historical transaction, inventory, or other data that are updated at some time interval (e.g., hourly, daily, monthly, quarterly, etc.).

Research data are pulled into the system (408) and preparation for the development of these models begins in Stage 1 (410), where data are aggregated based on similarity of characteristics (clustering) for each of the boosting models that are built around factors such as mileage, options, proxies for condition, and seasonality combined with regionality. For example, groupings of vehicles based on their typical annual mileage found in the data will be used for the mileage-adjustment model. In certain embodiments, models may be constructed on one or more different levels. Furthermore, there may be a set of models for each price which it is desired to determine. For example, there may be a set of models for list price, a set of models for sale price, and a set of models for trade-in price.

Stage 2 (412) is the creation of the boosting models for the various adjustment factors that will be applied to the pricing models (e.g., the national pricing models). A set of regression coefficients are determined (414) and used to generate the boosting tables (416). These tables, for a given set of vehicle attributes (e.g., year/make/model/trim), will be used by the front end to adjust the average market price based on mileage, location, seasonality, proxies for condition, etc.

Research data (418) may be used on a weekly basis to estimate the coefficients for a main model. First, the input data is normalized using the boosting models. For example, a data point with mileage higher than the average for that vehicle will have its mileage adjusted down to the average value and its price adjusted up based on boosting model output (416) to what it would have been if it had average mileage. Similar adjustments are made for seasonality, regionality, options, and proxies for condition. The result is a normalized input data set stage 3 (420). This dataset is used to produce average prices and the distribution of prices for each set of vehicle attributes (e.g., year/make/model/trim) as stage 4 (422). Stage 4 values are for the average vehicle based on all of the features considered (e.g., mileage, condition). The resulting national base values (424) will be made available for future steps.

Input data (426) will be available with each refresh of the inventory (e.g., of used vehicles for sale or which have sold), which may occur several times a day. Each piece of inventory may correspond, for example, to a used vehicle for sale or sold previously. These data will be mapped by the regression coefficients (424) to attach an average price and price distribution to each piece of inventory as if it were an average vehicle (e.g., average mileage, condition, etc.), as stage 5 (428). The inventory data combined with market information is stored as the Base Table goes through one more step for model year and trim rationalization (430). Finally, the data are adjusted by the boosting models (416) to produce the final market price average and distribution information for each specific piece of inventory, incorporating the pieces of inventory's attributes (e.g., mileage, condition, etc.), and made available for front-end inventory scoring (432).

### Stages 1-2 (410,412): Boosting Tables

The research data (408) pulled for Stage 1 (410) consists of a combination of listings and transaction data covering a long time period where the various relationships are expected to change gradually on some time frame, possibly quarterly. Vehicles are clustered into bins based on statistically similarity through clustering techniques. Here the similarities of models can be defined with make, body type, vehicle type (truck, SUV, coupe, convertible, etc.), engine, transmission, etc. The mileage boosting model, for example, may cluster all sports cars into one bin as they tend to be driven the same number of miles per year on average, while large pickup trucks may be clustered into their own bin for similar reasons. For each bin, the average or typical value is determined (e.g., 10,000 miles per year or no value-add options included) based on the available data. Next, regression is used to estimate the impact of varying away from the average or typical vehicle. For example, sports cars may lose an average of 1% of value for each additional 1,000 miles driven per year. The boosting models in Stage 2 (412) then produce regression coefficients (414) that power the boosting tables (416).

Y=β₀+ΣβᵢXᵢ+ε

where Y represents price and X represents the boosting factor for that specific model.

After classifying transactions data into clusters of vehicles having similar characteristics, research datasets 408 may be constructed for the vehicle pricing. In some embodiments, the research datasets are constructed using the following operations: 1) use of temporally-weighted historical data to generate a sufficient number of observations needed to draw inferences with acceptable confidence; 2) use of geo-specific socioeconomic variables to account for geographic differences in consumer behavior (e.g. median income, median home prices); and 3) vehicle-specific attributes (e.g. engine type, drive type).

Every historical transaction, yᵢ, can be used in the modeling process. However, use of a transaction that occurred in the very distant past may cause misleading results, particularly if the used-car market has witnessed recent changes such as the price jump due to supply interruptions caused by natural disasters or seasonal fluctuations. To put emphasis on more recent transactions and thereby more quickly capture change, a temporal weight is assigned to each observation based on its age in weeks. The approach used is an exponentially weighted moving average:

Sₜ=αYₜ₋₁+(1−α)Sₜ₋₁

Above, Sₜ represents the exponentially weighted moving average in week t, a is a parameter controlling how quickly historical transactions are discounted and Yₜ₋₁ is price of transactions occurring in week t−1.

It may be important to choose the appropriate value of α. An analysis of historical performance can be used to aid in the selection of the appropriate value. In the event where there are many transactions observed, say, in the last four (4) weeks, an unweighted average of these transactions can be used as it may provide a timely and robust measure or prices without relying upon historical data.

To account for the usage and maintenance of each vehicle, a set of variables y may be considered. These variables may include: 1) mileage on the vehicle, 2) condition of the vehicle; 3) title history. Title history is specific to individual vehicles. It indicates whether the vehicle has been properly maintained. This also helps estimate the actual condition of the vehicle.

Exemplary output tables are shown in FIG. 3. In the example illustrated, there is information for base national information for the specific trim in the first table (301), while one boosting model output table is exemplified by the second table (302).

### Stages 3-4 (420,422): National Base Values

Once these boosting tables (416) are produced, they may be used on a weekly basis to normalize listings and transaction data (418). Each historical transaction or listing is converted to the average or typical vehicle by backing out the boosting values contained in the boosting tables (416). The result is a dataset in Stage 3 (420) that is used to generate the base national models in Stage 4 (422). In this case, one of any statistical averaging techniques (e.g., simple average, median, minimized sum of squares) may be used to produce the national baseline valuation (424).

These values are aligned by model year and trim within each vehicle generation. A smoothing function of the following form is used to eliminate nonsensical relationships (newer model year is cheaper than older model year for essentially the same vehicle) due to sparsity of research data:

Y=βe^{-δt}

where β and δ are estimates from a non-linear fit regression model that has the functional form of the equation above, where the dependent variable, Y, is the natural log of the vehicle's value as determined by the national base value model. For this example, t is defined as vehicle age, computed as Today's Year less the Model Year of the vehicle. A similar relationship is determined for the various trim groupings.

To account for structural and pricing differences in each vehicle, a set of variables (x) may be considered. These variables may include: 1) the natural logarithm of the MSRP of the base vehicle without options, 2) natural logarithm of the ratio of MSRP of the vehicle with options and the base vehicle, 3) the vehicle body type (SUV, Van, Truck, Sedan, Coupe, Convertible), 4) fuel type (electric, diesel, hybrid, gasoline), 5) transmission type (automatic, manual), 6) drive type (4-wheel drive, front-wheel drive, rear-wheel drive) and 7) the number of cylinders in the vehicle's engine or other types of variables.

Because consumer demand may vary with geography based on the characteristics and taste of the local population, a set of variables (z) may be used. These variables may include, for example, geo-specific information obtained from data providers and the US Census Bureau (based on the most recent decennial census): 1) fraction of rural households in the locality compared to national percentage, 2) median home price in the locality compared to the national median home price, 3) percentage of work force participation in locality compared to national work force participation and, using another data source with the locations of all US car dealers 4) the number of vehicle dealerships for a specific make in the locality or other variables.

The number of days a vehicle has been for sale is an important factor for the listing price and the price at which the car is sold eventually. To observe the historical days to sell, the listings and transactions data may be merged to get the day a listing was added and the actual date the vehicle was sold. Then, the number of days to sell can be derived. Note that even for the exact same vehicle, it can be sold for different prices depending how long the vehicle has been for sale.

### Stage 5 (428): VIN-Specific Vehicle Valuation

Next, in Stage 5 (428), each individual VIN is mapped to a national base value and further mapped to factors where it differs from the average or typical vehicle, factors which may include (1) seasonality, (2) mileage, (3) proxies for condition, and (4) geography among other possible factors. The method used to boost the national base value will vary based on the factor. Some may be based on a Linear Regression used to generate estimates for the possible parameters:

Y=β₀+ΣβᵢXᵢ+ε

where Y is the VIN-specific valuation, the betas are the parameters that have been estimated, and the Xi's are the values for the boosting factors such as mileage, proxies for condition (which can be input as indicator variables or ordinal values), and geography (which can be input as indicator variables). This formula can then be used to obtain an accurate VIN-specific value for any vehicle, with any mileage, condition, and geographical location.

### Summary of Full Model

Here, a model is built for the normalized price ratio (pr) defined as

$$pr = \frac{price}{base MSRP when new}$$

relative to its weighted mean value of similar vehicles and regions. This work can be summarized by the equation:

prᵢ−p̅r̅_̅{̅q̅}̅=αₒ+αₘ+Σⱼβⱼ·xᵢ+Σₖδₖ·yₖ+Σₗλₗ·zₗ+Σₙθₙ·vₙ+εᵢ

Which can be rewritten in the more familiar form as:

prᵢ=p̅r̅_̅{̅q̅}̅+αₒ+αₘ+Σⱼβⱼ·xᵢ+Σₖδₖ·yₖ+Σₗλₗ·zₗ+Σₙθₙ·vₙ+εᵢ

Where

$$\overline{{pr}_{q}} = ( \frac{{\sum }_{i ∈ q} {w}_{i} {mr}_{i}}{{\sum }_{i ∈ q} {w}_{i}} )$$

In the preceding equation, the features in set x represent the set of regression variables which impact the price ratio such as vehicle attributes, the set y represents the usage/maintenance data, and the set z represents local-level customer and demographic information as well as industry-level data, the set v represents the days-to-sell data, αₒ is a global intercept term, αₘ is a make-level intercept applied only when i∈m, and p̅r̅_̅{̅q̅}̅ denotes a weighted average of the price ratios for the particular bin q. εᵢ is the error term.

The model can be fitted using weighted Ordinary Least Squares (OLS) to find the regression coefficients (i.e., the estimated parameters \hat{α}, \hat{β}, \hat{δ}, \hat{λ}, \hat{θ} that result in the smallest sum of temporally weighted squared residuals). The results are then stored (430) for use in deriving the final price in the front end, as will be discussed in greater detail below.

Given the results of the regression equation, the predicted price ratio of a vehicle i in a bin q is then [symbol] = [symbol] +p̅r̅_̅{̅q̅}̅, where [symbol] is the predicated price ratio that results from the model. The pr hat can be thought of as an estimate of how a vehicle differs from the average (pr bar).

The final estimated price for vehicle in transaction i is then [symbol] = [symbol] ×depreciated valueᵢ.

Note that in some embodiments, the regression step is gone through multiple times where price is changed to meet desired needs. Specifically, for a projection on recommended list price, list price data can be used as the dependent variable to predict list prices. If sale price is the goal, the process can be accomplished in the same fashion with list price as the dependent variable, which then provides us with a projection for recommended sale price.

Front-End Processing

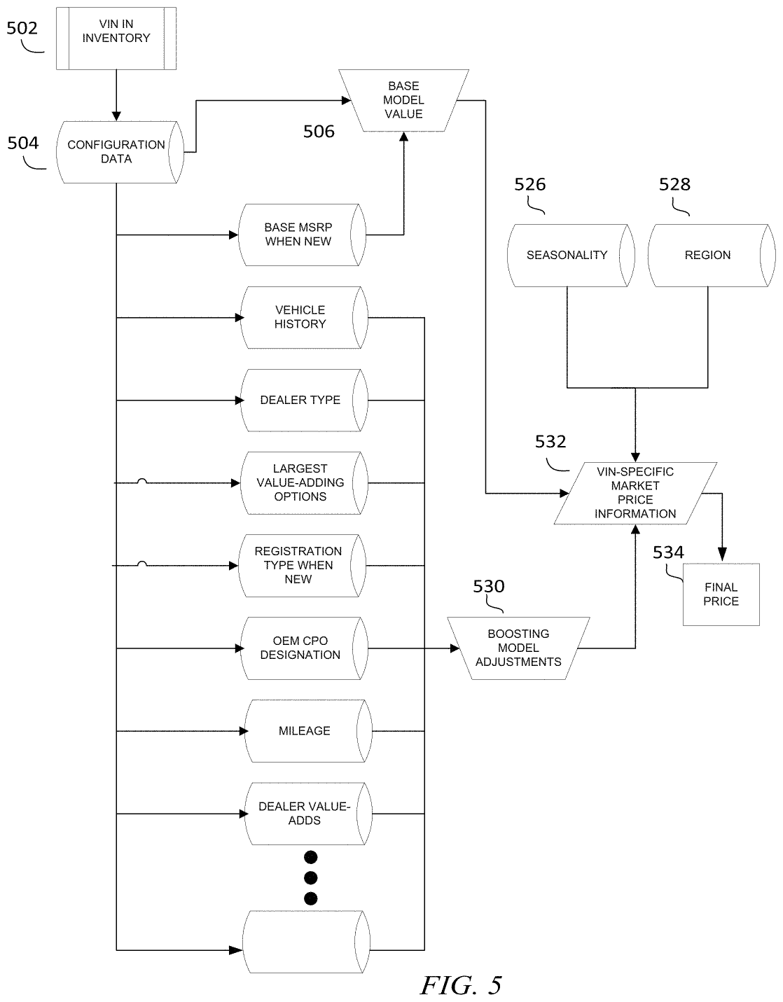

All of the above describes the construction of the linear regression models in the backend (400). Thus, using the data determined in the backend processes, the user may obtain pricing data for a specified vehicle using the frontend processing embodiments as depicted in FIG. 5. For example, a user may select the vehicle year, make, model, and trim. The user also may provide the zip code to estimate the price in. The User may also select other attributes including, for example, the vehicle condition, engine, transmission, drivetrain, and options subject to the selected vehicle trim; the use may also enter the mileage on the vehicle. After the user selects the vehicle and mileage and condition, then pricing data to display to the user may be algorithmically determined using models (as discussed above), including for example, list, sale, or trade-in pricing.

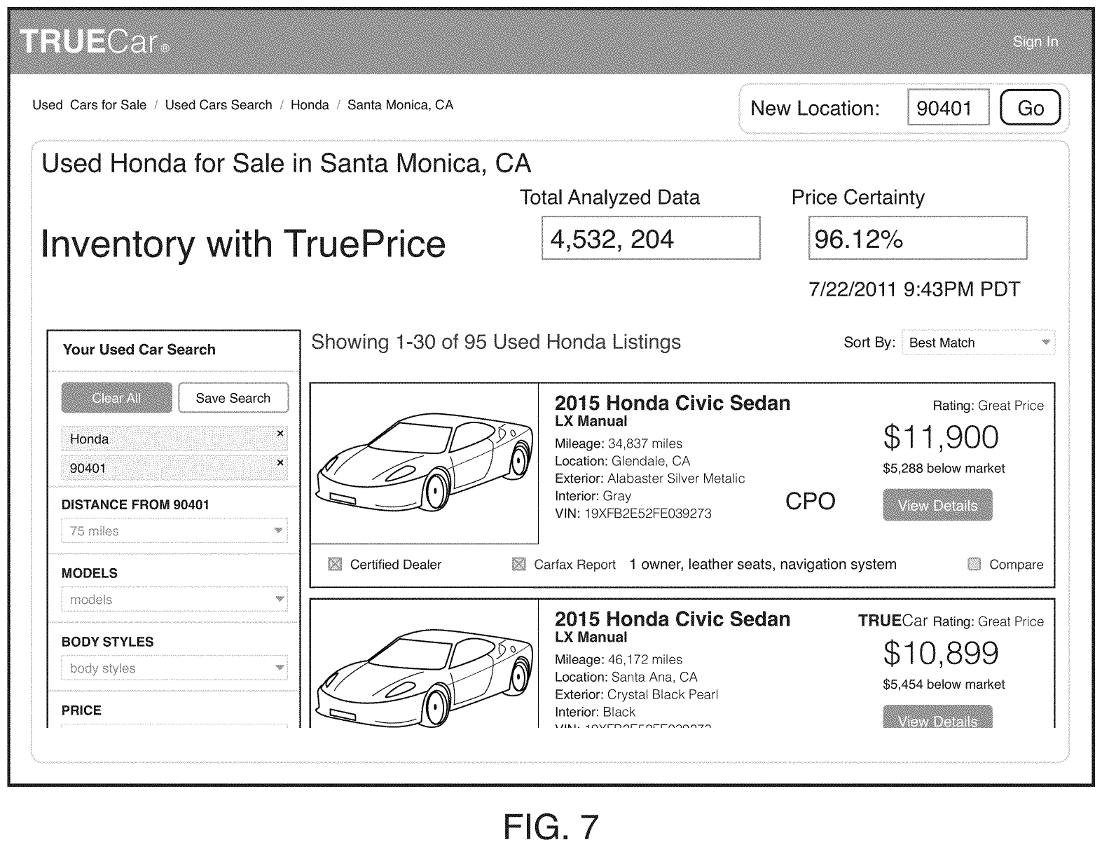

Additionally, in some embodiments, a vehicle may be displayed as part of the online inventory (502) based on the vehicle configuration such as year, make, model, and trim (as selected by the user through an interface). The vehicle may also be associated with a specific zip code (e.g., of the vehicle or as input by the user) or other configuration data which influences vehicle price (504). The data for the vehicle can then be uses to determine a base model value (506). The base model value can then be adjusted using VIN specific market price information (532), any seasonality (526) or region (528) data, and boosting model adjustments (530) as discussed above yielding a final price (534). Three embodiments of an interface which may be presented to a user to allow him to access such data are depicted in FIGS. 7, 8, and 9.

The inventory listing will also include proxies for the vehicle condition (based on vehicle characteristics and other information sources), engine, transmission, drivetrain, and options subject to the selected vehicle trim; mileage on the vehicle will also be included in the configuration data (504).

For the specific vehicle being displayed, pricing data to display to the user is algorithmically determined using models (as discussed above), including for example, list, sale, or trade-in pricing.

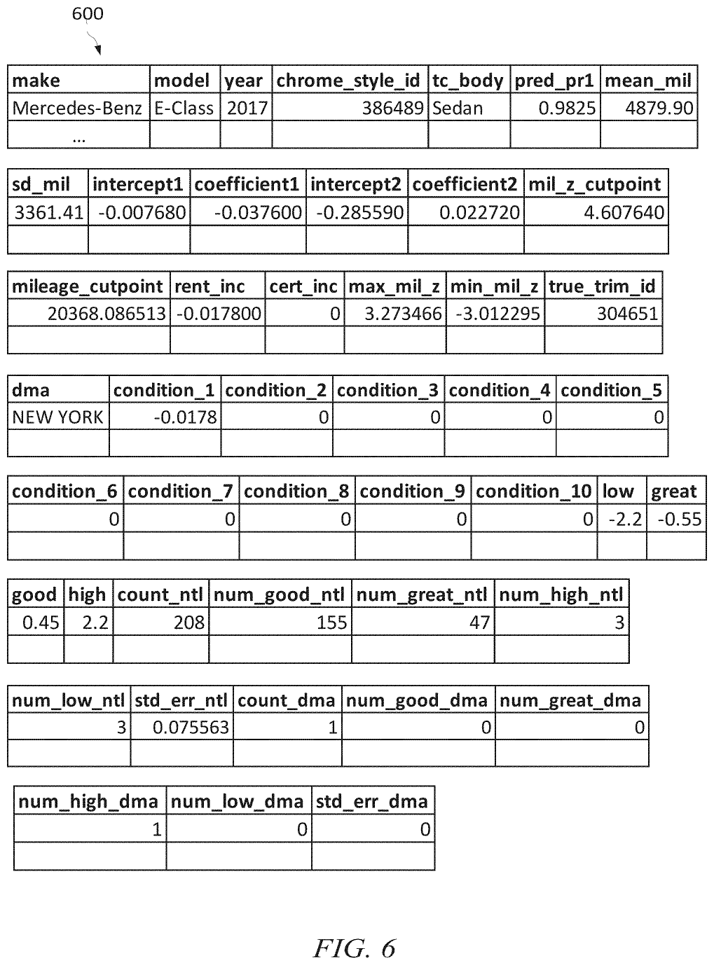

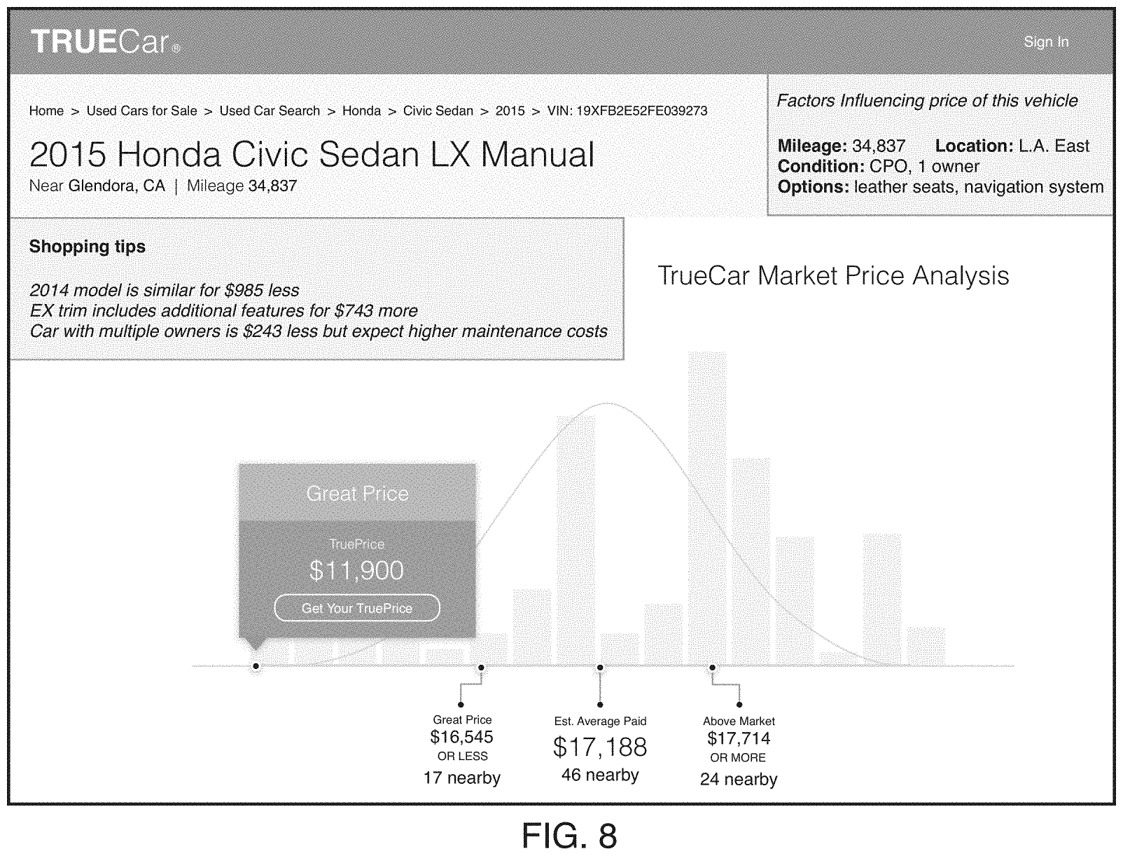

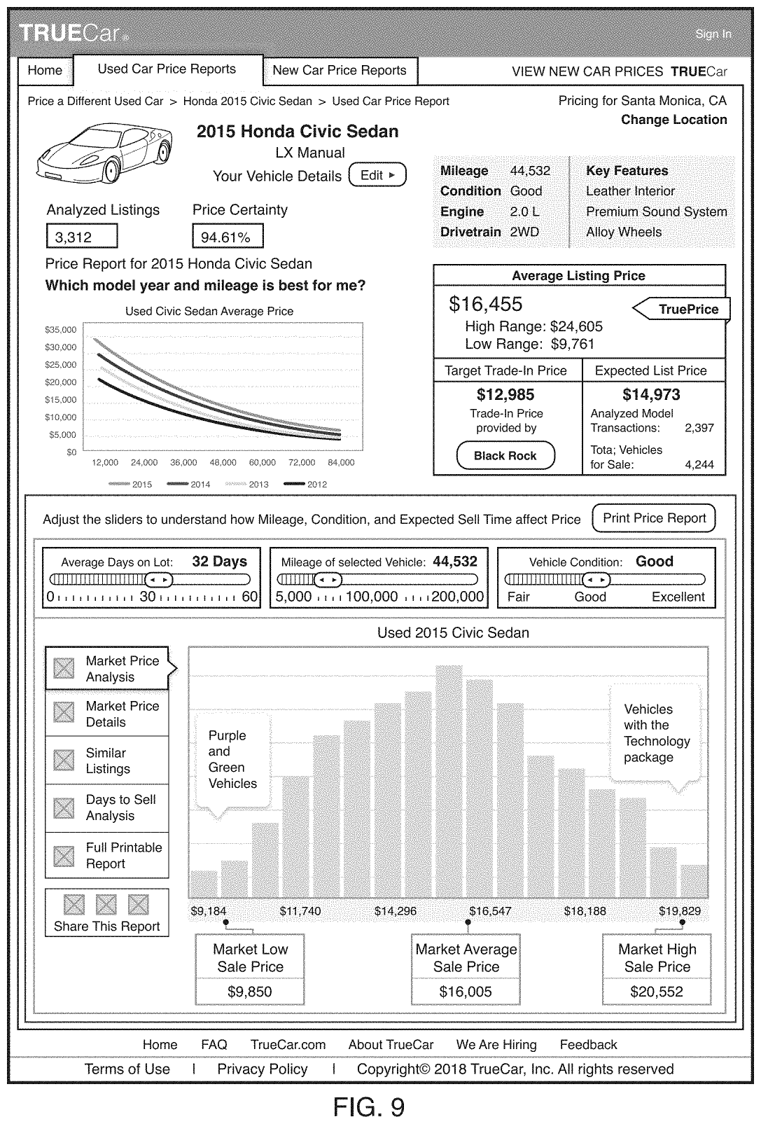

Thus, a series of pricing calculations happens in order to present pricing data. The calculations may be done using a model determined in the back end processing as described above. This may involve data on the vehicle:
A bin q may be determined based on user input (e.g., a selected vehicle configuration or location).
All historical transactions may be pulled together from the same bin q as the user-selected vehicle in order to calculate the average price ratio. An example of the pricing data for a particular vehicle is shown in the table of FIG. 6. For example, if the user views a 2009 Honda Civic LX in the 90401 zip code, as well as additional information described above, the result would be to pull the pricing information, including average price and the distribution, for that specific VIN based on the lookup table exemplified by FIG. 6.
The regression coefficients \hat{α}, \hat{β}, \hat{δ}, \hat{λ}, \hat{θ} (e.g., which may have been pre-calculated in the backend), may be plugged into the regression variable sets x, y, z, v (as well as the average price ratio), and an expected price ratio may be obtained: [symbol] = [symbol] +p̅r̅_̅{̅q̅}̅. A residual or depreciated value using the user-input data may be calculated based upon the decay curve and depreciation function that has been developed.
Given the depreciated value calculated above, the expected price can be obtained: [symbol] = [symbol] ×base MSRPᵢ along with other pricing data that may be displayed to the user as illustrated in FIGS. 8 and 9. The determined pricing data is thus presented to a user. Accordingly, a user can access a price report where pricing data including expected sale price and list price are presented. Again, embodiments of an interface which may be presented to a user with such pricing data is depicted in FIGS. 7, 8, and 9. The user may have the ability to enter additional frontend information to modify calculations further. Specifically, in some embodiments, the user can enter changes to the vehicle condition, mileage, and the anticipated days to sell. With changes to these selected elements, specific frontend algorithmic adjustments may be made and presented to the user through the interface.

Embodiments disclosed herein may be implemented in or in conjunction with embodiments disclosed in U.S. patent application Ser. No. 12/556,076, filed Sep. 9, 2009, and entitled “SYSTEM AND METHOD FOR AGGREGATION, ANALYSIS, PRESENTATION AND MONETIZATION OF PRICING DATA FOR VEHICLES AND OTHER COMMODITIES,” which is hereby incorporated by reference in its entirety. It should be noted that the embodiments depicted therein may be used in association with specific embodiments and any language used to describe such embodiments, including any language that may be in any way construed as restrictive or limiting (e.g., must, needed, required, etc.) should only be construed as applying to that, or those, particular embodiments.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include RAMs, ROMs, HDs, data cartridges, magnetic tapes, floppy diskettes, flash memory drives, optical data storage devices, CD-ROMs, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” or “a set” (and “the” when antecedent basis is “a” or “an” or “a set”) includes both singular and plural of such term, unless clearly indicated otherwise (i.e., that the reference “a” or “an” or “a set” clearly indicates only the singular or only the plural). Also, as used in the description herein and throughout, the meaning of “in” includes “in” and “on” unless the context clearly dictates otherwise.

What is claimed is:

1. A vehicle data system comprising:
a processor;
a non-transitory computer-readable medium comprising instructions executable by the processor for:
obtaining data from distributed data sources, the data from the distributed data sources including transaction data comprising:
individual transaction data for a plurality of vehicles having a plurality of vehicle configurations in a plurality of geographic regions, wherein each vehicle configuration in the plurality of vehicle configurations comprise one or more factors, including a year, make and model, and
wherein the individual sales transaction data for the plurality of vehicles comprises sale prices and vehicle specific usage data for the plurality of vehicles;
storing, in a data store, the transaction data for the plurality of vehicle configurations;
performing a process divided into a back end process and a front end online process, the back end process performed at a time interval and asynchronously to the front end online-process,
wherein the back end process comprises:
clustering the plurality of vehicles based on the vehicle configurations and geographic regions
generating a boosting model from the transaction data, the boosting model modelling pricing adjustments for an average vehicle based on the one or more vehicle configuration factors;
generating a regionality model based on the transaction data and the plurality of geographic regions;
adjusting the transaction data by applying the boosting model to the transaction data to adjust the sales price associated with each individual sales transaction;
creating a geographic region base model for each of the plurality of vehicle configurations from the adjusted transaction data, the geographic region base model including a geographic region base price;
storing, in the data store, the boosting model and the geographic region base model; and
wherein the front end online process comprises:
presenting a user interface through a client device;
receiving user input data via the web-based form from the client device over the network user input data comprising information about a used vehicle in a locale, including a used vehicle configuration including values for each of the one or more factors for the used vehicle configuration;
determining a base model value for the used vehicle using the geographic region base model for the used vehicle configuration;
adjusting the base model value for the used vehicle using the boosting model to generate a final price for the used vehicle configuration based on the values for each of the one or more factors for the used vehicle configuration;
adjusting the final price for the used vehicle based on the locale and the regionality model;
generating a responsive web page including the final price for the used vehicle; and
communicating the responsive web page to the client device, wherein the responsive web page is generated and communicated to the client device in response to the vehicle data system receiving the user input data from the client device.

2. The system of claim 1, wherein the back end process comprises comparing the geographic region base price for each of a set of related vehicle configuration to determine if the geographic region base prices for the set represent a logical progression.

3. The system of claim 1, wherein the geographic region for the geographic region base model is nationwide.

4. The system of claim 1, wherein the boosting model includes a set of boosting models, each of the set of boosting models corresponding to one of the one or more vehicle configuration factors.

5. The system of claim 4, wherein the set of boosting models comprises a VIN-specific vehicle valuation boosting model.

6. The system of claim 1, wherein the final price is a list, sale, or trade-in price.

7. A method comprising:
obtaining data from distributed data sources, the data from the distributed data sources including transaction data comprising:
individual transaction data for a plurality of vehicles having a plurality of vehicle configurations in a plurality of geographic regions, wherein each vehicle configuration in the plurality of vehicle configurations comprise one or more factors, including a year, make and model, and
wherein the individual sales transaction data for the plurality of vehicles comprises sale prices and vehicle specific usage data for the plurality of vehicles;
storing, in a data store, the transaction data for the plurality of vehicle configurations;
performing a process divided into a back end process and a front end online process, the back end process performed at a time interval and asynchronously to the front end online-process,
wherein the back end process comprises:
clustering the plurality of vehicles based on the vehicle configurations and geographic regions
generating a boosting model from the transaction data, the boosting model modelling pricing adjustments for an average vehicle based on the one or more vehicle configuration factors;
generating a regionality model based on the transaction data and the plurality of geographic regions;
adjusting the transaction data by applying the boosting model to the transaction data to adjust the sales price associated with each individual sales transaction;
creating a geographic region base model for each of the plurality of vehicle configurations from the adjusted transaction data, the geographic region base model including a geographic region base price;
storing, in the data store, the boosting model and the geographic region base model; and
wherein the front end online process comprises:
presenting a user interface through a client device;
receiving user input data via the web-based form from the client device over the network user input data comprising information about a used vehicle in a locale, including a used vehicle configuration including values for each of the one or more factors for the used vehicle configuration;
determining a base model value for the used vehicle using the geographic region base model for the used vehicle configuration;
adjusting the base model value for the used vehicle using the boosting model to generate a final price for the used vehicle configuration based on the values for each of the one or more factors for the used vehicle configuration;
adjusting the final price for the used vehicle based on the locale and the regionality model;
generating a responsive web page including the final price for the used vehicle; and
communicating the responsive web page to the client device, wherein the responsive web page is generated and communicated to the client device in response to the vehicle data system receiving the user input data from the client device.

8. The method of claim 7, wherein the back end process comprises comparing the geographic region base price for each of a set of related vehicle configuration to determine if the geographic region base prices for the set represent a logical progression.

9. The method of claim 7, wherein the geographic region for the geographic region base model is nationwide.

10. The method of claim 7, wherein the boosting model includes a set of boosting models, each of the set of boosting models corresponding to one of the one or more vehicle configuration factors.

11. The method of claim 10, wherein the set of boosting models comprises a VIN-specific vehicle valuation boosting model.

12. The method of claim 7, wherein the final price is a list, sale, or trade-in price.

13. A non-transitory computer readable medium, comprising instructions for:
obtaining data from distributed data sources, the data from the distributed data sources including transaction data comprising:
individual transaction data for a plurality of vehicles having a plurality of vehicle configurations in a plurality of geographic regions, wherein each vehicle configuration in the plurality of vehicle configurations comprise one or more factors, including a year, make and model, and
wherein the individual sales transaction data for the plurality of vehicles comprises sale prices and vehicle specific usage data for the plurality of vehicles;
storing, in a data store, the transaction data for the plurality of vehicle configurations;
performing a process divided into a back end process and a front end online process, the back end process performed at a time interval and asynchronously to the front end online-process,
wherein the back end process comprises:
clustering the plurality of vehicles based on the vehicle configurations and geographic regions
generating a boosting model from the transaction data, the boosting model modelling pricing adjustments for an average vehicle based on the one or more vehicle configuration factors;
generating a regionality model based on the transaction data and the plurality of geographic regions;
adjusting the transaction data by applying the boosting model to the transaction data to adjust the sales price associated with each individual sales transaction;
creating a geographic region base model for each of the plurality of vehicle configurations from the adjusted transaction data, the geographic region base model including a geographic region base price;
storing, in the data store, the boosting model and the geographic region base model; and
wherein the front end online process comprises:
presenting a user interface through a client device;
receiving user input data via the web-based form from the client device over the network user input data comprising information about a used vehicle in a locale, including a used vehicle configuration including values for each of the one or more factors for the used vehicle configuration;
determining a base model value for the used vehicle using the geographic region base model for the used vehicle configuration;
adjusting the base model value for the used vehicle using the boosting model to generate a final price for the used vehicle configuration based on the values for each of the one or more factors for the used vehicle configuration;
adjusting the final price for the used vehicle based on the locale and the regionality model;
generating a responsive web page including the final price for the used vehicle; and
communicating the responsive web page to the client device, wherein the responsive web page is generated and communicated to the client device in response to the vehicle data system receiving the user input data from the client device.

14. The non-transitory computer readable medium of claim 13, wherein the back end process comprises comparing the geographic region base price for each of a set of related vehicle configuration to determine if the geographic region base prices for the set represent a logical progression.

15. The non-transitory computer readable medium of claim 13, wherein the geographic region for the geographic region base model is nationwide.

16. The non-transitory computer readable medium of claim 13, wherein the boosting model includes a set of boosting models, each of the set of boosting models corresponding to one of the one or more vehicle configuration factors.

17. The non-transitory computer readable medium of claim 16, wherein the set of boosting models comprises a VIN-specific vehicle valuation boosting model.

18. The non-transitory computer readable medium of claim 13, wherein the final price is a list, sale, or trade-in price.
